(19) United States
(12) Patent Application Publication
(10) Pub. No.: US 2026/0228400 A1
(43) Pub. Date: Aug. 6, 2026

(54) FULL-SURFACE DETACHED VORTICITY METHOD FOR SOLVING FLUID DYNAMICS

(71) Applicant: Jesus Carlos Pimentel-Garcia, Mexico (MX)

(72) Inventor: Jesus Carlos Pimentel-Garcia, Mexico (MX)

(21) Appl. No.: 19/151,304

(22) PCT Filed: Feb. 8, 2024
(86) PCT No.: PCT/MX2024/050007

§ 371 Date: Jul. 25, 2025

Related U.S. Application Data
(60) Provisional application No. 63/444,340, filed on Feb. 9, 2023.

(51) Int. Cl. G06F 30/28; G06F 17/12; G06F 111/10; G06F 113/08

(52) U.S. Cl. CPC G06F 30/28; G06F 17/12; G06F 2111/10; G06F 2113/08

(57) ABSTRACT

A numerical method for solving three-dimensional fluid flow using a velocity-vorticity approach is presented. Within the family of potential flow-based methods, an extension of the vortex lattice method (VLM) has been developed due to its relative simplicity. This extension demonstrates a fully non-linear detached circulation-vorticity hypothesis within the framework of potential flow theory: vorticity is generated at the entire surface, then detached, naturally advected, stretched, and diffused. The results obtained explain and solve fundamental aspects of fluid dynamics, such as the generation of lift (and drag), with outstanding precision, despite relatively coarse discretization and low computational cost. Therefore, it should be considered the cornerstone for future implementations aimed at solving more complex fluid flow phenomena within Lagrangian or meshless Computational Fluid Dynamics (CFD).

### BACKGROUND ART

The presently disclosed embodiments are related to the fundamentals of fluid dynamics by extending the current interpretation of potential flow and vorticity concepts in order to solve for three-dimensional fluid flow around objects.

Numerical methods based on potential flow theory (PFT), more commonly known as panel methods, have been used satisfactorily for several decades, primarily in aerodynamics, to solve attached flow conditions around streamlined configurations (e.g., airfoils, wings, or aircraft). Due to their relative ease of implementation and low computational cost, these methods are mainly employed during the conceptual design phase to obtain the acting force, moments, and pressure distributions of an aerodynamic or hydrodynamic nature. One of the main references describing several panel methods (including the vortex lattice method; VLM) is J. Katz and A. Plotkin's “Low-Speed Aerodynamics” (Cambridge University Press, 2001). This bibliography includes theoretical and numerical implementations for ideal flows (assumed inviscid, incompressible, and irrotational), ranging from a single vortex element to unsteady three-dimensional formulations. However, potential-based methods suffer from major problems as they cannot be satisfactorily applied to detached flows (with their inherently attached circulation-vorticity scheme), since their application is limited to the low angle of attack (AoA) range.

In the field of potential-based numerical codes, only a few models have been published that attempt to solve detached flow past an object using a circulation-vorticity approach. As mentioned, PFT has mainly been applied to cases where the fluid is assumed to be perfectly attached to the surface. One of these developments is Gersten's non-linear model, described in H. Schlichting and E. Truckenbrodt's “Aerodynamics of the Airplane” (1979), which is limited to considering a constant circulation distribution only along the spanwise direction and an arbitrary wake orientation (α/2). Related to Gersten's model is the “nonlinear vortex lattice method” presented by J. Rom, C. Zorea, and R. Gordon in “On the calculation of non-linear aerodynamic characteristics and the near vortex wake” (1974). In its straight wakes version, this method has the inconvenience of detaching its wakes downstream based on lifting line theory (LLT)—specifically, from a quarter panel chord—rather than from the trailing segments of each bounded vortex ring (BVR), as in VLM. This problem is aggravated by the fact that the chordwise discretization shown in that reference is extremely low (two or four panels), thus significantly underestimating the leading edge vortex (LEV) detachment. Another deficiency of this model is that it considers vorticity detachment only along the lateral edges of the rectangular thin flat plate, while the inner vortices remain embedded (attached circulation to the surface). Furthermore, this model shares the same deficiency as Gersten's nonlinear model (on which it is based) by considering an arbitrary wake alignment with half the AoA (α/2). Finally, the wake roll-up version of this model shows an overestimated lift coefficient (CL) from 15 deg. of AoA (for a quadrangular flat plate case) compared to experimental results.

In a 1993 NASA technical memorandum, “LinAir: a multi-element discrete vortex Weissinger aerodynamic prediction method”, D. D. Durston presents a numerical method based on Weissinger's LLT. This method is represented by discrete horseshoe vortices (without a continuous distribution of circulation) and includes the semi-empirical Polhamus suction analogy to account for the leading-edge (LE) suction effect. Due to this latter approach, the method proved uninteresting as a basis for the current model development. This is because it requires the calculation of suction parameters based on external (experimental) values, thus making it a semi-empirical model. However, the circulation scheme shown in this reference, by including additional detached wakes along the chordwise direction, constitutes an approach to be considered for the construction of a more complex model within the scope of potential-based methods.

Based on the current state of the art, no steady-state numerical model rooted in circulation-vorticity has been reported that is truly based on full multiple wake VLM concepts. Such a model would offer the advantage of precisely calculating circulation over the entire surface (along both chordwise and spanwise directions) by considering flow separation between all discretized panels, including all external edges.

To follow the natural development from steady to unsteady solutions and to extend the scope of the disclosed embodiments, vortex methods (VMs), as described in G. S. Winckelmans' “Vortex Methods” (Encyclopedia of Computational Mechanics, Second Edition, 2017), allow approximating the solution of the Navier-Stokes equations in their velocity-vorticity form. Thus, only the existing vorticity regions are discretized by Lagrangian elements; the remaining space is kept empty. This is the main advantage over mesh-based methods, as it saves computational effort. Such vortex elements can be mainly isolated vortex filaments, vortex tubes, vortons, or blobs, all of which carry concentrations of vorticity. Then, the vorticity field D\vec{ω}/Dt develops in time according to the velocity field, where both the vortex tilting-stretching (\vec{ω}·∇̅)\vec{u} and viscous diffusion ν∇²\vec{ω} terms are included.

J. Strickland, G. Homicz, V. Porter, and A. Gossler, in “A 3-D vortex code for parachute flow predictions: version 1.0” (Sandia National Laboratories, 2002), present a hybrid vortex tube-vorton method similar to the one described in the disclosed embodiments. However, the main difference between the two is the vorticity generation scheme. In the cited manuscript, one vortex is generated per discretized surface element, while in the present method, it is generated along all the edges corresponding to those surface elements. This increases the level of precision, as the latter allows for the correct orientation of each nascent vortex. Moreover, in the cited manuscript, such an orientation calculation is not detailed; only the circulation strength is. Besides, in the previous method, the vorticity volumes remain constant throughout the simulation, which inherently violates the circulation conservation law. Although the former method appears conceptually and theoretically well-justified, its final results are questionable, showing high scatter and overestimated values for all its validation cases (massively detached flow past parachute canopies).

Patent “Fluid Simulation Program” (JP2004126925A) describes a vortex method similar to the one presented in the disclosed embodiments. However, the main difference between the two methods is the mechanism of vorticity generation near a solid surface, specifically whether it is viscous or inviscid. In this invention, a vortex blob is generated per discretized surface element based on additional and more complex calculations, as the generation of vorticity on the surface relies on viscous calculations. These details are described in A. Ojima and K. Kamemoto's “Numerical Simulation of Unsteady Flow around Three Dimensional Bluff Bodies by an Advanced Vortex Method” (Journal of Materials Science and Engineering, 2000). While the current invention is based on an inviscid vorticity generation mechanism, the implementation of a viscous one, as previously described, is not excluded if deemed necessary.

Another patent related to the present vortex method is “System and Method for Simulating Turbulence” (US20210124861A1). This patent focuses on algorithms for removing loops and reconnecting advected filaments to save computational time within the context of the vortex filament method (VFM). Regarding the generation of surface vorticity, it points to a vortex tube generator module based on vorticity generation through different vortex sheet layers (described in detail in a related patent, U.S. Pat. No. 6,512,999), which represents a viscous approach. In contrast, in the present disclosed embodiments, such vorticity generation is assumed to be based on a purely inviscid mechanism, as previously stated. As for turbulence treatment, since the present disclosed embodiments focus on solving fundamentals and numerical accuracy rather than implementation or computational efficiency (e.g., fast multipole method; FMM), no turbulence model is currently implemented. Theoretically, at the upper limit of vortex element method (VEM) discretization, all turbulent scales are explicitly solved, similar to mesh-based direct numerical simulation (DNS), which also does not require wall or Kolmogorov scale modeling. However, future developments of the current invention could include a large eddy simulation (LES)-based turbulence model, which would save computational time for higher-fidelity simulations.

### SUMMARY OF THE INVENTION

A purely numerical method for computing three-dimensional fluid flow past an object by a vortex-panel method is presented. The well-known limitation of current potential flow-based methods is their ability to model satisfactorily only under the attached flow assumption, since all circulation-vorticity is embedded at the object surface, except at some separation lines, such as trailing or lateral (wing tip) edges. Within such a family of methods, the low-order vortex lattice method (VLM) has been chosen for its simplicity in exploring a full-surface detached circulation-vorticity hypothesis: “If the fluid viscosity value is zero, then there must be no attached flow, especially through a plate with a sharp leading edge”. Since the current interpretation of potential flow theory imposes an attached flow scheme, it is directly confronted with its own supposed inviscid assumption for an ideal flow (irrotational, incompressible, and inviscid). In other words, from this new perspective, the flow must be detached from such an edge, and along and across the entire surface, because the inertial forces of the flow are infinitely greater than the viscous (zero) ones (upper limit of the Reynolds number). To investigate this hypothesis, the developed methodology consists of adding groups of detached vortex wakes from the surface and external edges of a shell body, verifying each sub-model until reaching a final full-flow detachment model (The Full Multi-wake Vortex Lattice Method), including the leading edge vortex (LEV). The steady-state (straight wake assumption) results obtained are consistent with those expected for different aspect ratio flat plate configurations within their application range, even under sideslip conditions. Furthermore, its development has been extended to a vortex element method (The Full Non-linear Vortex Tube-Vorton Method), which allows capturing aerodynamic properties (not only for lift but also for drag and pitching moment) with outstanding accuracy, with relatively low discretization and low computational cost. The results obtained show that by implementing a Lagrangian vorticity-based approach, it is possible to approximate the Navier-Stokes equations in their velocity-vorticity form accurately without the need to incorporate turbulence models to determine the separation of the three-dimensional flow. Such models are still semi-empirical and require external parameters based on physical experiments, a condition that should ideally be avoided obtaining a method as pure as possible, reducing the input parameters to a minimum and avoiding problems attributable to Eulerian methods, such as numerical dissipation.

### BRIEF DESCRIPTION OF DRAWINGS

FIG. 1 Bounded and wake vortex rings for Multi-Trailing Edge (MTE) sub-model (2×2 discretization; exploded view).

FIG. 2 Bounded and wake vortex rings for MTE plus all lateral sub-model (2×2 discretization; exploded view).

FIG. 3 Bounded and wake vortex rings for the final model of the FMVLM (2×2 discretization; exploded view).

FIG. 4 Detached vortex ring representation between two adjacent bounded vortex rings (2×1; exploded view).

FIG. 5 Final conceptual representation of the Full Multi-wake Vortex Lattice Method (2×2 discretization; exploded view).

FIG. 6 Assumptions of circulation continuity and discontinuity (Kutta-type) along two edges for different types of wakes (single panel; exploded view).

FIG. 7 Top view of the flow past a 4×4 quadrangular flat plate using the Unsteady Full Multi-Wake Vortex Lattice Method (UFVLM) during the verification phase.

FIG. 8 Flow past a 16×16 quadrangular flat plate was solved using the Full Non-linear Vortex Tube-Vorton Method (FTVM) during its validation phase.

FIG. 9 Hybrid vortex tube-vorton element representation with its corresponding isolated vortex filament.

FIG. 10A Flowchart of the Full Non-linear Vortex Tube-Vorton Method (first part; shaded operations are included within the claims).

FIG. 10B Flowchart of the Full Non-linear Vortex Tube-Vorton Method (second part; shaded operations are included within the claims).

FIG. 11 Representation of multi-vortons per vortex filament.

FIG. 12A Top view of a single-vorton per bounded vortex filament discretization for a quadrangular flat plate (4×4).

FIG. 12B Top view of the multi-vorton per-bounded-vortex-filament discretization for a quadrangular flat plate (4×4).

FIG. 13A Top view of the bounded and wake vortex filaments, along with their corresponding vortons, for a 2×2 quadrangular flat plate.

FIG. 13B Side view of the bounded and wake vortex filaments, along with their corresponding vortons, for a 2×2 quadrangular flat plate.

FIG. 14A Top view of the bounded and wake vortons (transparent) and their corresponding isolated vortex filaments for a 4×4 quadrangular flat plate after 5 iterations.

FIG. 14B Side view of the bounded and wake vortons (transparent) and their corresponding isolated vortex filaments for a 4×4 quadrangular flat plate after 5 iterations.

FIG. 14C Front view of the bounded and wake vortons (transparent) and their corresponding isolated vortex filaments for a 4×4 quadrangular flat plate after 5 iterations.

FIG. 15A Flowchart of precise, variable volumes of vorticity for vortex squeezing-stretching (first part).

FIG. 15B Flowchart of precise, variable volumes of vorticity for vortex squeezing-stretching (second part).

FIG. 16A Hybrid vortex tube-vorton element with its corresponding isolated vortex filament before advection at the endpoints (a₀ and b₀).

FIG. 16B New vortex filament position after advection of the endpoints (a₁ and b₁); the corresponding vorton is hidden.

FIG. 16C New vortex tube volume is obtained by precisely maintaining both vorticity and circulation after the vortex filament's advection.

FIG. 16D New vorton volume is obtained from the corresponding vortex tube volume (inviscid case).

FIG. 16E New vorton (blob) volume is obtained from the corresponding vortex tube volume (viscous case).

FIG. 17A Evolution of the lift coefficient throughout time for a 16×16 quadrangular flat plate at different angles of attack is shown using the Full Non-linear Vortex Tube-Vorton Method.

FIG. 17B Evolution of the inviscid drag coefficient over time for a 16×16 quadrangular flat plate at different angles of attack is shown using the Full Non-linear Vortex Tube-Vorton Method.

FIG. 17C Evolution of the pitching moment coefficient (around the quarter chord) throughout time for a 16×16 quadrangular flat plate at different angles of attack is shown using the Full Non-linear Vortex Tube-Vorton Method.

FIG. 18A Averaged lift coefficient vs. angle of attack for a 16×16 quadrangular flat plate using the Full Non-linear Vortex Tube-Vorton Method.

FIG. 18B Averaged inviscid drag coefficient vs. angle of attack for a 16×16 quadrangular flat plate using the Full Non-linear Vortex Tube-Vorton Method.

FIG. 18C Averaged pitching moment coefficient (around quarter-chord) vs. angle of attack for a 16×16 quadrangular flat plate using the Full Non-linear Vortex Tube-Vorton Method.

### DETAILED DESCRIPTION OF THE PREFERRED EMBODIMENTS

Hereinafter, the fluid simulation method according to the present disclosed embodiments will be described in detail with reference to the drawings.

The preferred embodiment is described for the system of equations assembly for a thin quadrangular flat plate, aligned laterally with the free-stream direction (non-sideslip condition). Such a procedure should be considered as the basis not only for the disclosed embodiments but also for the extension to other panel methods (e.g., doublet-source panel), with the understanding that the potential flow concepts here applied work the same for all of them, since only the influence coefficients matrix (ICM) of the system of equations is modified.

From the well-known linear system of equations that defines the flow solution in the standard VLM (and other panel methods):

$${A}^{=} \vec{Γ} = \vec{RHS} \qquad ( 1 )$$

where A̅ is the general or total ICM, \vec{Γ} is the circulation strength (or intensity) vector of the BVRs attached to each physical panel, and \vec{RHS} is the right-hand side vector due to the free-stream contribution. Note that only A̅ is modified in the current steady-state model by summing the additional wake contributions to the system of equations.

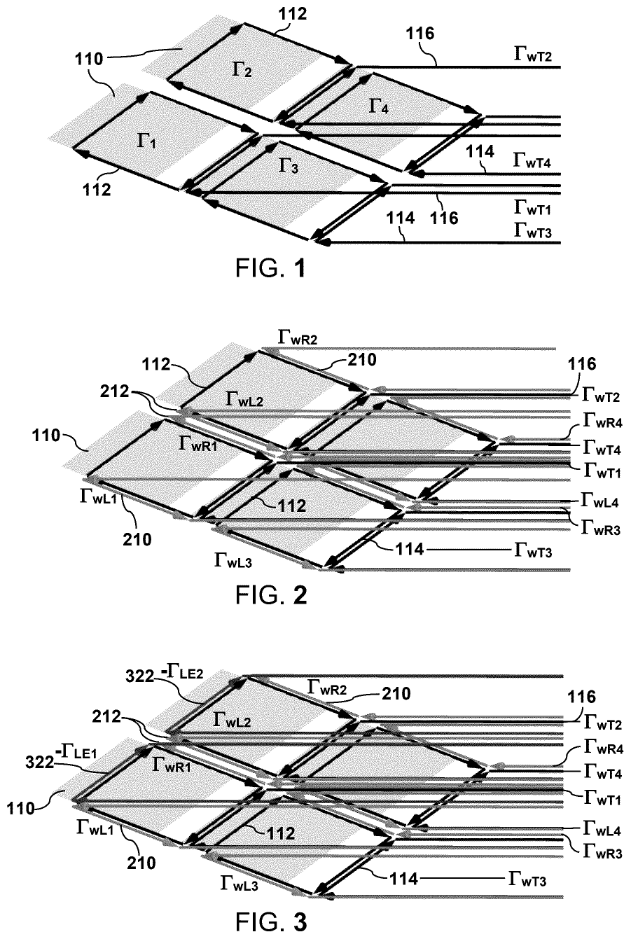

The development of two sub-models and a final model is presented below in an exploded view to increase the level of detail. FIG. 1 describes the first sub-model developed, “Multiple Trailing Edges” (MTE). This sub-model was developed in the most natural way by adding the group of chordwise vortex rings 116 (except the plate's trailing edge, TE), called longitudinal or trailing vortex rings, to the standard VLM (vortex rings 114 emitted only from the plate's trailing edge). At this stage, the plate's LE will be treated differently due to its numerical nature. Note that the TE wake effect in the standard VLM is determined by adding the contribution of each wake vortex ring (WVR) to a specific matrix element of the total ICM (which includes body and wake influences) when assembling the system of equations. This implicitly imposes the Kutta condition along the plate's TE. The same reasoning applies to the addition of the remaining trailing vortex rings 116 since the Kutta condition is automatically fulfilled. At this point, all physical panels 110 have an associated trailing edge condition. Because of this, the total ICM is affected by all vortex rings 114, 116 corresponding to the trailing edge wakes.

For example, for a discretized 2×2 flat plate, the total ICM (body plus wake) based on unitary vortex strengths yields:

$${A}^{=} = [ \begin{matrix}{A}_{b 11} + {A}_{wT 11} & {A}_{b 12} + {A}_{wT 12} & {A}_{b 13} + {A}_{wT 13} & {A}_{b 14} + {A}_{wT 14} \\ {A}_{b 21} + {A}_{wT 21} & {A}_{b 22} + {A}_{wT 22} & {A}_{b 23} + {A}_{wT 23} & {A}_{b 24} + {A}_{wT 24} \\ {A}_{b 31} + {A}_{wT 31} & {A}_{b 32} + {A}_{wT 32} & {A}_{b 33} + {A}_{wT 33} & {A}_{b 34} + {A}_{wT 34} \\ {A}_{b 41} + {A}_{wT 41} & {A}_{b 42} + {A}_{wT 42} & {A}_{b 43} + {A}_{wT 43} & {A}_{b 44} + {A}_{wT 44}\end{matrix} ] \qquad ( 2 )$$

where the first numerical subscript represents the control point, which is related to the body's panel 110. The second subscript corresponds to the effect of each bounded 112 (for subscript b) or trailing (for subscript wT) vortex ring 114, 116. The ICM is now assembled. As mentioned earlier, the right-hand side (RHS) calculation remains unchanged compared to the standard VLM procedure.

FIG. 2 shows the next stage (the second sub-model: MTE+all lateral) of the preferred embodiment. This stage involves adding all lateral vortex rings (external 210 and internal 212) by applying the same reasoning used for the previous group of added wakes. This reasoning involves assigning a positive unitary circulation value to each WVR segment according to the criterion of a clockwise circulation direction. During the ICM assembly, note that each panel adds its influence coefficients through the trailing (T) edge vortex rings 114, 116, as well as the left (L) and right (R) lateral ones. For the outer panels, this is 210, 212; for the inner panels, this is 212 on both sides.

For the 2×2 example, the ICM yields the following:

$${A}^{=} = [ \begin{matrix}{A}_{b 11} + {A}_{K 11} & {A}_{b 12} + {A}_{K 12} & {A}_{b 13} + {A}_{K 13} & {A}_{b 14} + {A}_{K 14} \\ {A}_{b 21} + {A}_{K 21} & {A}_{b 22} + {A}_{K 22} & {A}_{b 23} + {A}_{K 23} & {A}_{b 24} + {A}_{K 24} \\ {A}_{b 31} + {A}_{K 31} & {A}_{b 32} + {A}_{K 32} & {A}_{b 33} + {A}_{K 33} & {A}_{b 34} + {A}_{K 34} \\ {A}_{b 41} + {A}_{K 41} & {A}_{b 42} + {A}_{K 42} & {A}_{b 43} + {A}_{K 43} & {A}_{b 44} + {A}_{K 44}\end{matrix} ] \qquad ( 3 )$$

$$being :$$

$${A}_{Kij} = {A}_{wTij} + {A}_{wLij} + {A}_{wRij} \qquad ( 4 )$$

where A_{Kij} represents the sum of all j-vortex rings of the panel with the Kutta (K) condition (T, L, and R for trailing, left, and right, respectively) over i-control points. Note that A_{wTij} comes from the previous sub-model (MTE).

FIG. 3 shows the final (third) sub-model, the Full Multiwake VLM or “FMVLM”. As demonstrated, adding the LE vortex rings 322 substantially improves the CL (and consequently, the induced drag or CDi) results. In this case, unlike in the previous two sub-models, the value of such WVRs (and their vortex segments) detached from the LE body panels is given an opposite sign (the direction is inverted; attached LEV scheme). Following the clockwise convention for circulation direction, its value must be −Γ (minus one during system of equations assembly).

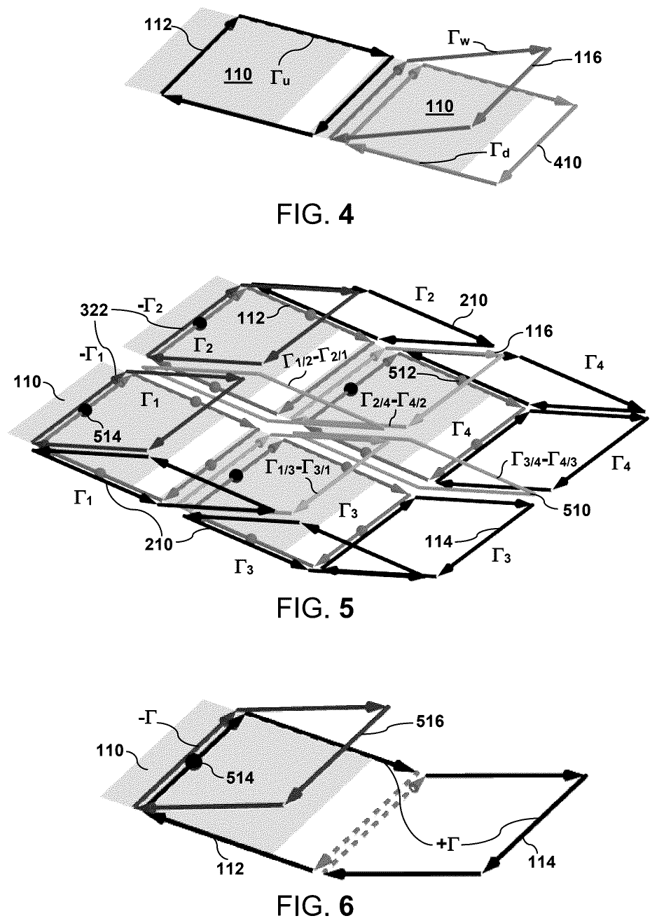

Mathematically, the sign inversion of circulation strength for an LE vortex ring 322 can be explained by the following definition: the WVR strength (Γ_{w}) 116 detached between two panels is equal to the upstream (Γᵤ) 112 minus the downstream (Γ_{d}) 410 circulations of the BVRs (see FIG. 4):

$${Γ}_{w} = {Γ}_{u} - {Γ}_{d} \qquad ( 5 )$$

Thus, if the upstream BVR 112 is absent (Γᵤ=0), as is the case with all of the LE panels on the plate:

$${Γ}_{w} = - {Γ}_{d} \qquad ( 6 )$$

This means that during the system of equations assembly, the LE WVRs' 322 circulation must equal minus the BVRs' 112 circulation. This simple operation, when applied to the entire plate's LE, allows for the numerical consideration of the LE suction effect, thereby improving the numerical results for CL and CDi compared to the analytical values (and the simpler VLM results) obtained via Jones's linear theory, as presented in R. T. Jones's “Properties of Low Aspect Ratio Pointed Wings at Speeds Below and Above the Speed of Sound” (1946) and further elaborated on in S. F. Hoerner's “Fluid-Dynamic Drag” (1965) for various low AR flat plate configurations.

Continuing with the 2×2 example, the ICM yields the following:

$${A}^{=} = [ \begin{matrix}{A}_{b 11} + {A}_{K 11} + {A}_{11} & {A}_{b 12} + {A}_{K 12} + {A}_{12} & {A}_{b 13} + {A}_{K 13} & {A}_{b 14} + {A}_{K 14} \\ {A}_{b 21} + {A}_{K 21} + {A}_{21} & {A}_{b 22} + {A}_{K 22} + {A}_{22} & {A}_{b 23} + {A}_{K 23} & {A}_{b 24} + {A}_{K 24} \\ {A}_{b 31} + {A}_{K 31} + {A}_{31} & {A}_{b 32} + {A}_{K 32} + {A}_{32} & {A}_{b 33} + {A}_{K 33} & {A}_{b 34} + {A}_{K 34} \\ {A}_{b 41} + {A}_{K 41} + {A}_{41} & {A}_{b 42} + {A}_{K 42} + {A}_{42} & {A}_{b 43} + {A}_{K 43} & {A}_{b 44} + {A}_{K 44}\end{matrix} ] \qquad ( 7 )$$

being A_{LEij} the influence coefficient of the j-WVR 322 (the negative sign of the LE is implicit) over the i-control point. As can be seen, only LE panels (1 and 2) provide this contribution to certain matrix elements (the first two columns). Note that A_{Kij} comes from the previous sub-model (MTE+all lateral).

At this point, the system of equations assembly for the steady FMVLM (straight wake version) has been developed. Each BVR 112 surrounds four WVRs: upstream 116 or 322, downstream 114 or 116, and two laterals 220 and/or 218, depending on its position in the plate. All of them are aligned with the free-stream direction. As shown earlier during the development of both simpler sub-models, the upstream WVR 116 can be considered a shared wake between the upstream and downstream panels (strictly in the flat plate case). To simplify and achieve consistency in the model, both contiguous lateral wakes 220 can be merged/collapsed into one, which is shared between two panels, as shown in FIG. 5.

After solving the linear system in Eq. (1) to find the circulation strengths of the BVRs 112 (using the same procedure as standard), the well-known Kutta-Joukovski (KJ) load calculation method is performed to find the force vector (d\vec{F}) on each bounded vortex segment on which such a load acts.

$$d \vec{F} = {ρ}_{∞} Γ ( \vec{U} \times d \vec{l} ) \qquad ( 8 )$$

where ρ_{∞} is the flow density, Γ is the circulation strength, and d\vec{l} is the length of the vortex segment where the force vector is calculated. \vec{U} is the local velocity at the midpoint of the vortex segment. The local velocity at the midpoint of each vortex segment is considered as the sum of the induced velocity from all BVRs 112 and WVRs 114, 116, 210, 212, 322 plus the free-stream velocity. This is the total flow velocity.

FIG. 5 graphically describes the WVR's circulation strength calculation. In general, the circulation value of all external vortex ring wakes (detached from the trailing edge 114, the sides 210, and the LE 322 of the plate) is taken from the BVRs 112 that generate them. This implicitly imposes the Kutta condition on each detachment edge (vortex segment), except for the LE's WVRs, which invert its sign. For all internal WVRs (trailing 116 and lateral 510), the circulation strength value is obtained by subtracting the circulation of both contiguous BVRs 112 that generate it.

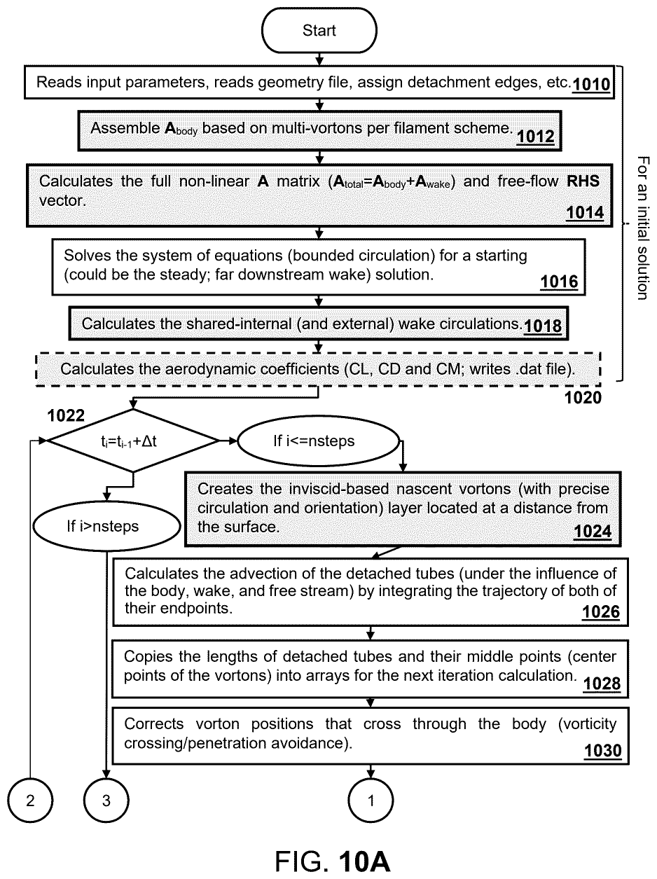

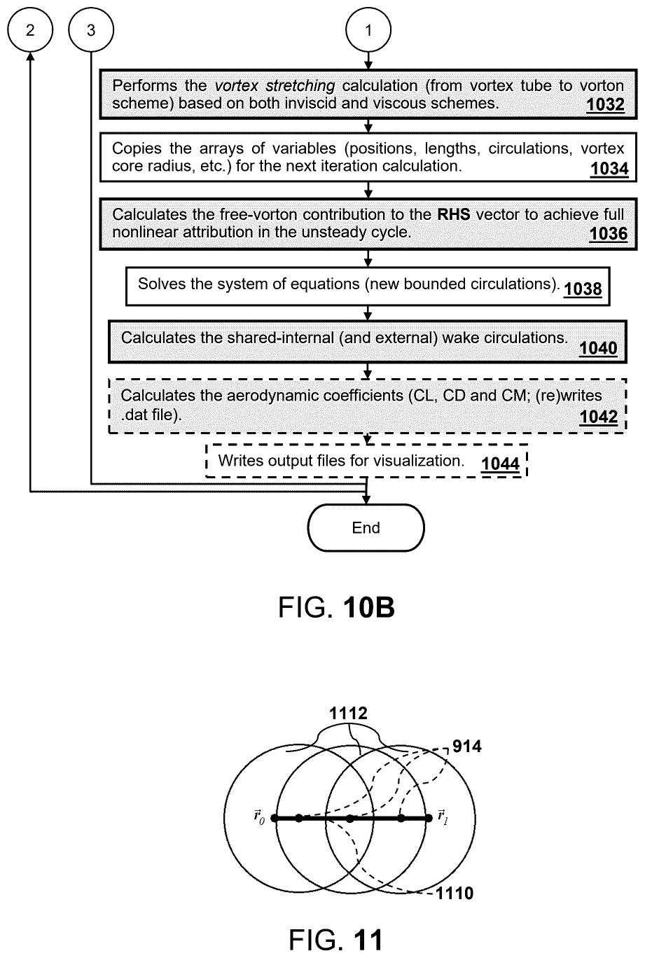

At this point, the calculation of the vector strength of the bounded segment is described. As in the standard VLM, the vortex segments corresponding to the panel's TEs that are contiguous to 114 do not contribute to the calculation of the aerodynamic load via KJ. This also applies to all edges with detached vortex rings, as well as the lateral edges of the panel contiguous to 210 and 510 in the non-sideslip case of the FMVLM. However, the external and internal panel LEs contiguous to 116 and 322 are not considered Kutta-type edges and are therefore an exception. Since it does not cancel its strength (Γ=0), the Kutta condition cannot be applied to those edges. For example, in a single panel with all detached vortex rings 114, 210, 322, the last consideration ensures that no bounded vortex segment contributes to the aerodynamic load calculation. In this case, the force vector is equal to zero, meaning that no lift or induced drag is provided, which is a nonphysical result. This is only valid for a stalled plate where the LE vortex rings 322 have the same circulation direction as their BVR 112; detached LEV. Regarding the latter, the vector strength of a LE-bounded segment on 514 cannot be considered twice (2Γ) due to the assumption of a wake discontinuity along such an edge. This discontinuity is related to the inverted sign of the wake. Strictly, only the bounded segment corresponding to 514 contributes to the load calculation, not the wake (see FIG. 6). Schematically, the load calculation via KJ for a 2×2 FMVLM is represented in FIG. 5. In this figure, only the LE-bounded segments on 514 contribute to the aerodynamic coefficient calculation. The remaining segments on 512 automatically fulfill the Kutta condition. The flowchart corresponding to the previously shown steady methodology is similar to those shown in block operations 1010, 1012, 1014, 1016, 1018, and 1020 in FIG. 10A.

The corresponding numerical results for the lift, drag, and pitching moment coefficients obtained using the previously described methodology can be found in J. C. Pimentel's article “The Full Multi-wake Vortex Lattice Method: a detached flow model based on Potential Flow Theory” (Advances in Aerodynamics, 2023). Although the FMVLM has been applied to structured meshes (quadrilaterals), it can also be applied to unstructured meshes (e.g., triangles or a combination of quadrilaterals and triangles), with the understanding that the operating principles remain the same under the same theoretical formulation (PFT).

During the development of the current steady multi-wake model, it was demonstrated that the system of equations assembly and the calculation of aerodynamic loads for the FMVLM follow a well-structured, logical process based entirely on potential flow and VLM concepts. The developed numerical method avoids the main drawbacks of the standard VLM and its improvements by adding lateral (wing tip) wakes 518, which considers the flow as fully attached to the surface. The corresponding open-source code is available for download at https://github.com/CPimentelMx/MultiVLM.

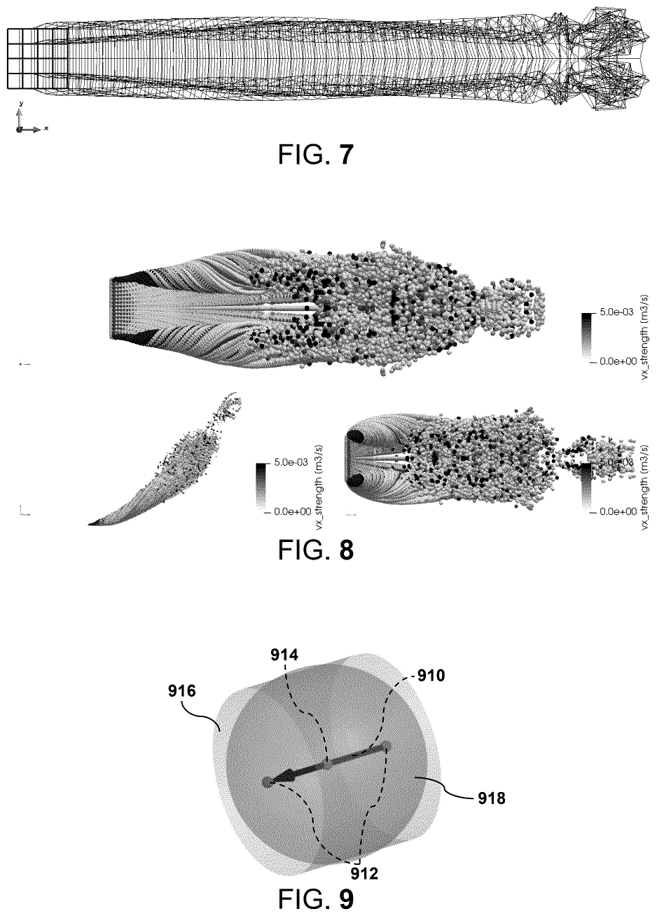

FIG. 7 shows the Unsteady Full Multi-wake Vortex Lattice Method (UFVLM), which is a natural extension of the previously described methodology and its time-marching solution. Its development should be considered an intermediate step between the conceptual model and the most recent vortex element-based model. The verification and validation phases are thoroughly explained in J. C. Pimentel's pre-print “The Unsteady Full Multi-wake Vortex Lattice Method: a full rolled-up detached vorticity approach” (Researchgate.net, 2023). Such a methodology focuses more on algorithmics and testing than practical aspects, so it is not explained due to its limitations (it precisely replicates straight wake behavior, which limits its application range). However, most of its concepts are incorporated in the next stage of development, except for the type of element selected (isolated vortex filaments instead of closed vortex rings). The corresponding open-source code (UMultiVLM) can be downloaded from https://github.com/CPimentelMx/UMultiVLM

FIG. 8 shows the result of the flow past a quadrangular flat plate at incidence (α=40 deg.) obtained through the hybrid vortex tube-vorton method (see FIG. 9), which was published in J. C. Pimentel's article “The Full Non-linear Vortex Tube-Vorton Method: the pre-stall condition” (Advances in Aerodynamics, 2024). The latter method, “FTVM”, extends the previously disclosed embodiments via the FMVLM. The FTVM is based on a hybrid scheme of isolated vortex tubes 916 (regularized filaments with their associated vectors 910) and spherical vorticity elements (vortons) 918 to discretize both the body and the wake.

FIG. 9 shows the schematic of an isolated vortex filament vector 910, which consists of two endpoints 912 and one middle point 914. Each vortex filament corresponds to a cylindrical vortex volume, or vortex tube 916, with the same circulation (Γ). Each vortex tube can be represented by a spherical vortex volume (vorton) 918 with the same volume (V) and vorticity (ω). This description forms the basis of the numerical method explained in the following embodiments.

FIG. 10 shows the operation blocks corresponding to the FTVM's flowchart. Most of these blocks are not claimed in the disclosed embodiments because they correspond to standard procedures, which are briefly described below. However, six blocks (shaded) must be considered significant contributions and claimed throughout the disclosed embodiments: 1012, 1014, 1018, 1020, 1024, and 1032. Blocks 1036, 1040, and 1042 correspond to similar operations in blocks 1014, 1018, and 1020, respectively, but for the unsteady case.

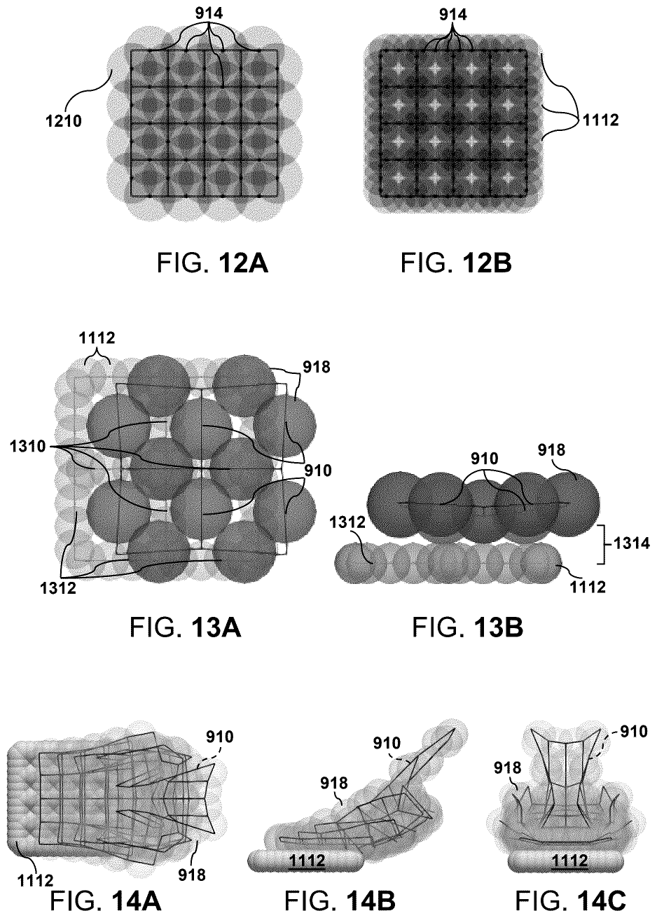

After starting the code to obtain an initial solution from a steady-state or impulsively accelerated condition, parameters such as the angle of attack (α), time step (Δt), nascent vortex core radius (σ₀), and nascent vortex distance from the surface (ε), among others, are read from input file 1010. Additionally, the geometry is read from the corresponding file to generate a surface mesh, and the edges with flow detachment are also read from there. Next, the body's influence coefficient matrix (ICM) A̅_{body} IS assembled based on the multi-vortons per vortex filament scheme 1012 (see FIG. 11), in which each bounded vortex filament is transformed into a set of vortons. See FIG. 12A and FIG. 12B for a 4×4 flat plate case. The next step is to calculate a fully coupled total ICM (A̅), considering the influence of all vortex elements detached from surface 1014, as described in Eq. (7). Notice that the wake vortex filaments are transformed into a set of vortons through the multi-vortons-per-vortex-filament scheme to maintain consistency during assembly. In other words, this operation completely transforms the scheme shown in FIG. 5 into its multi-vortons version. The free-flow RHS vector is also calculated at this step. As mentioned previously, this calculation does not require any additional treatment compared to the standard procedure. Then, the system of equations is solved to find the bounded circulation strengths (Γ_{b}) 1016. Its solution depends on the selected total wake length (φ), e.g., a relatively small value for an impulsively accelerated case. The next operation described in the disclosed embodiments is based on calculating the internal (and external, if applicable) wake circulation strengths (Γ_{w}) 1018, as shown in FIG. 5. This procedure has been previously described in the corresponding section (by subtracting the bounded circulations to determine the correct vortex ring strength and orientation). The final procedure in the initial solution stage is to calculate the aerodynamic coefficients and pressure distributions and write the results to output data file 1020. As usual, this step is optional (shown with a dashed contour) within the flowchart.

After achieving an initial solution with precise, bounded circulation strengths and orientations by incorporating a multi-wake detachment scheme, the time-dependent or unsteady cycle begins 1022. The procedure is practically the same for all iterations and is described below. The first step in each unsteady cycle is to create a nascent vortex layer with precise circulation and orientation obtained from the previous iteration's solution. This layer can be located at a prescribed or calculated distance (ε) from surface 1024, as shown in FIG. 13B. Note that this creation does not require additional viscous calculations, as in patents JP2004126925A and U.S. Pat. No. 6,512,999, because it is assumed that vorticity creation on the surfaces is a purely inviscid mechanism. Therefore, this operation falls within the scope of the disclosed embodiments, as the nascent vortex must be assigned the correct circulation strength and orientation. This is a crucial step in achieving the results obtained thus far, as it directly impacts the precision of the simulation. The next operation block calculates the advection of each detached vortex tube by numerically integrating its trajectory 1026 (e.g., second-order Adams-Bashforth or third-order Runge-Kutta) at both endpoints 912. This advection step is performed under the influence of the velocity field generated by the body, the free stream, and the wake. However, the wake is excluded in the first iteration, as there are no detached vortex elements yet. In 1028, the current vortons' center points 914 and the detached vortex tube lengths (ΔL) and middle point positions ({x, y, z}) are stored properly for the next iterative calculation. After this operation, the vorticity crossing/penetration avoidance routine 1030 is performed to prevent non-physical behavior by adjusting the positions of the vortex elements near the body's surface. This operation is one of the most challenging tasks in particle-based methods. However, the current code has simplified it by solving relatively low-complexity shapes. The next step is to perform calculation, which involves vortex tilting, squeezing, and stretching 1032, based on both inviscid (pure advection) and viscous schemes (e.g., through the core spreading method). Such a calculation is performed using a precise circulation conservation approach (Kelvin's circulation theorem), which involves varying the vortex volumes at each time step in order to achieve a perfectly stable method with zero residual. This operation is included within the claims of the present, disclosed embodiments since it is a novel numerical scheme that obeys the full multi-wake scheme. The next step is to copy the variables, such as positions ({x, y, z}), lengths (ΔL), circulations (Γ), and modified vortex core radius (σ), into the corresponding arrays 1034. These arrays are useful for the next iterative calculation. In 1036, the free vortons' contribution to the RHS vector is calculated by considering the entire vorton cloud's influence on control points. This calculation is similar to the one performed in 1014 for the steady-state case (reflected on the total ICM instead on the RHS). For this reason, this operation is also included in the scope of the disclosed embodiments, as accounting for all wake vorticity contributions is necessary to achieve a precise solution. Next, the system of equations 1038 is solved to determine the new bound circulation strengths. Then, a calculation is performed for the internal and external wake circulation strengths 1040 (if applicable), as in 1018 for the initial solution. This calculation is also claimed within the disclosed embodiments. Numerical results, such as aerodynamic coefficients and pressure distribution, are written to the corresponding optional output data file 1042. Finally, the output files for visualization (vortex elements, grids, contours, etc.) are written in 1044 (optional task performed at each iteration). After performing all the described operations in sequential order, a new cycle begins 1022 until the maximum number of iterations is achieved, at which point the simulation ends. The corresponding open-source code, VortoNeX, can be downloaded for analysis: https://github.com/CPimentelMx/VortoNeX.

FIG. 11 shows a multi-vorton 1112 per vortex filament 1110 scheme, which is useful for increasing the precision of the body's induced velocity field calculation. This is done by replacing a vortex filament 1110 by a set of equivalent vortons, where circulation, vorticity, and volume are conserved. The vortons 1112 are centered at 914. The distance between each vorton's center point 914 along the filament axis is obtained by:

$$‖ Δ {\vec{L}}_{v} ‖ = ‖ \frac{{\vec{r}}_{1} - {\vec{r}}_{0}}{ceil ( ‖ {\vec{r}}_{1} - {\vec{r}}_{0} ‖ / {σ}_{0} ) + 1} ‖ \qquad ( 9 )$$

The nascent vortex core radius (σ₀) is an input parameter based on surface mesh discretization that maintains an overlap of one (λ=1; see FIG. 12A for a 4×4 flat plate case) between the closest bounded vortons before converting each bounded vortex filament into multi-vortons (see FIG. 12B for a 4×4 flat plate case). Then, the corresponding vectorial circulation for each child vorton (\vec{Γ}_{child}) 1112, which must be recalculated at each iteration. It is obtained from both the corresponding scalar circulation (Γ) and the length vector (Δ\vec{L}_{ν}) by:

$${\vec{{Γ}_{}}}_{child} = Δ {\vec{L}}_{v} Γ \qquad ( 10 )$$

To maintain constant vorticity along the parent vortex filament (a vortex tube represented by a vorton of the same volume 1210) and the new child vortex tubes-vortons after splitting 1112, the volumes of vorticity must decrease according to the calculation of the new vortex core radius:

$${σ}_{child} = \frac{{σ}_{0}}{{[ ceil ( ‖ {\vec{r}}_{1} - {\vec{r}}_{0} ‖ / {σ}_{0} ) + 1 ]}^{\frac{1}{3}}} \qquad ( 11 )$$

This final calculation guarantees that the total volume, or the sum of all the child vortons' volumes 1112, equals the parent (unsplitted) vortex element 1210. This calculation is performed only once. Then, the volumes of the child bounded vortons 1112 remain constant throughout the entire simulation because they depend only on discretization. However, their corresponding circulation strengths and orientations are recalculated at each iteration according to the previous instantaneous solution.

FIGS. 13A (top view) and 13B (side view) show the structure of bounded 1310 and detached 918 vortons (48 and 12, respectively) after the first iteration for a 2×2 flat plate case. The number of bounded vortons is obtained through the multi-vortex filament scheme 1012, while the number of detached vortons corresponds to the number of internal 1310 filaments plus the number of external 1312 bounded filaments on the surface. Note that in the current scheme, each detached vorton corresponds to a regularized filament 910 (vortex tube-vorton) through a single-vorton-per-vortex-filament scheme (see FIG. 9). As mentioned previously, the bounded vorton volumes are calculated to preserve the nascent vorton volumes based on a nominal nascent vortex core radius (σ₀), which is an input parameter that depends on discretization. In the case of bounded vortons 1112, their volumes remain constant throughout the entire simulation as said before. They only vary in circulation and orientation according to the calculated instantaneous solution. In contrast, the volumes of detached vortons 918 can vary at each iteration or remain the same (for a constant volume scheme), depending on a precise vortex squeezing-stretching calculation 1032. In the current scheme, the layer of nascent vortons is located away from the surface by a prescribed distance 1314 (e.g., ε=σ₀). In FIG. 13B, notice that after the first iteration step, the detached vortons have already been advected downstream from their original release position.

FIG. 14A (top view), FIG. 14B (side view) and FIG. 14C (front view) show the vortex filaments 910 and their corresponding vortons 918 (with transparency) for a flat plate at incidence, discretized by bounded vortons 1112 after 5 iterations. The vortex tilting-squeezing-stretching calculation can be performed most precisely using this multi-filament scheme because it allows vortex volumes to vary while conserving total vorticity and circulation throughout the entire simulation. Note that some vortex filaments are disconnected from each other (see FIG. 14B) because they collided with the body at some previous time step. At that instant, the divergence-free grid is lost. More details on two alternative implementations (perfectly divergence-free but not strictly physical) can be found in the corresponding reference.

Here, a precise vortex tilting-squeezing/stretching scheme based on the temporal variation of vorticity volumes (dV/dt≠0) is described. As can easily be demonstrated, a constant-volume scheme violates the conservation of circulation for a vortex element (tube or vorton) between two consecutive time steps, since ∥\vec{Γ}∥ₜ=∥\vec{Γ}∥_{t+Δt} according to Helmholtz's law, if the vorticity increases due to elongation of the vortex tube after advection, its volume must proportionally decrease and vice versa.

$${‖ \vec{Γ} ‖}_{t} = {‖ \vec{ω} ‖}_{t} {V}_{t} = {‖ \vec{ω} ‖}_{t + Δ t} {V}_{t + Δ t} = {‖ \vec{Γ} ‖}_{t + Δ t} \qquad ( 12 )$$

Thus, the new volume of vorticity (V_{t+Δt}) can be determined using the following numerical scheme.

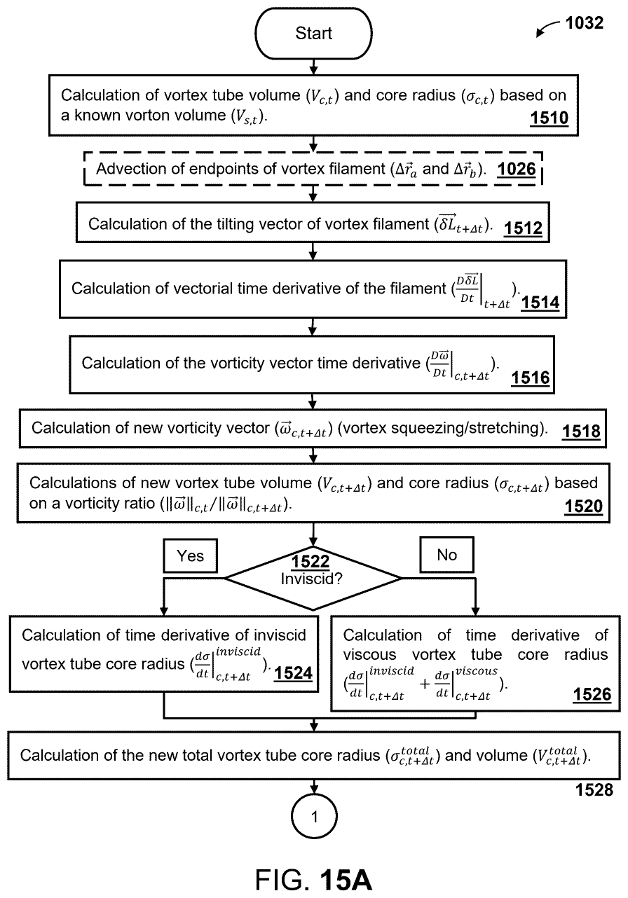

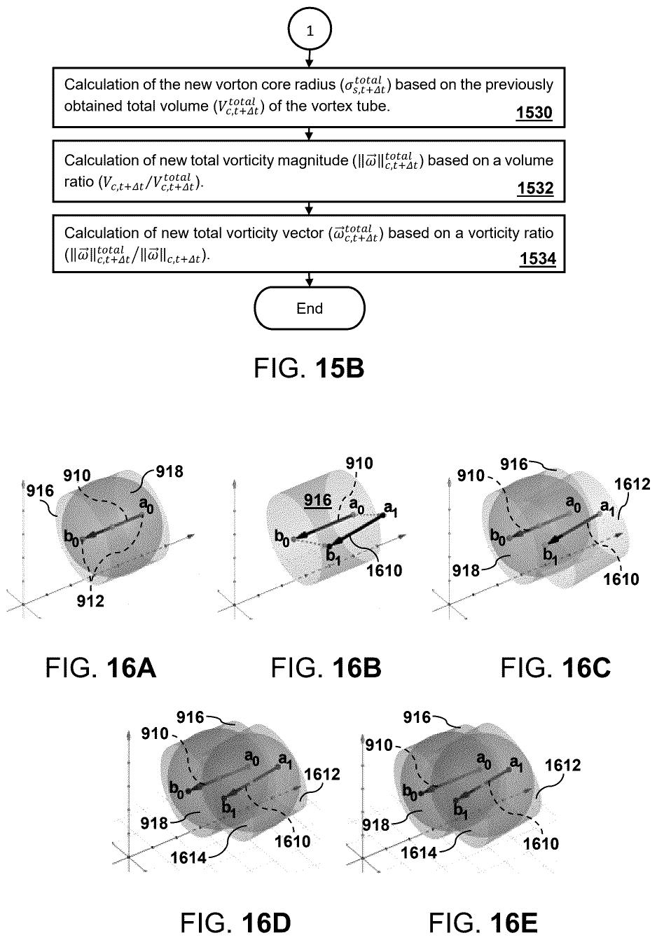

FIG. 15 shows the precise vortex squeezing-stretching calculation 1032 flowchart, which describes how to calculate the volume variation for a vortex element between two consecutive time steps. From a previous iteration, the corresponding vorton volume (V_{s,t}) 918 is known (see FIG. 16A). At the same time-step, the cylindrical (c) 916 and spherical(s) 918 volumes are assumed to be equivalent to conserve their properties:

$${V}_{s , t} = \frac{4}{3} π {σ}_{s , t}^{3} = {V}_{c , t} = π {σ}_{c ,}^{2} {‖ \vec{δ L} ‖}_{t} \qquad ( 13 )$$

Thus, the vortex tube volume (V_{c,t}) is easily obtained. Then, the vortex core radius (σ_{c,t}) is calculated as follows:

$${σ}_{c , t} = \sqrt{\frac{{V}_{s , t}}{π {‖ \vec{δ L} ‖}_{t}}} = \sqrt{\frac{4}{3} \frac{{σ}_{s , t}^{3}}{{‖ \vec{δ L} ‖}_{t}}} \qquad ( 14 )$$

These calculations were performed in 1510. After the advection step 1026 for the vortex filament endpoints 912 is completed (see FIG. 16B), the tilting vector (\vec{δL}_{t+Δt}) 1610 of the new vortex filament is obtained in 1512. Thus, given that the tilting vector (\vec{δL}ₜ) 910 of the previous vortex filament is known, the vectorial time derivative 1514 of the vortex filament is obtained by:

$$\frac{D \vec{δ L}}{Dt} {\vert}_{t + Δ t} = \frac{{\vec{δ L}}_{t + Δ t} - {\vec{δ L}}_{t}}{Δ t} \qquad ( 15 )$$

where both tilting vectors 1610, 910 are defined as follows:

$${\vec{δ L}}_{t + Δ t} = {\{ δ {L}_{x} , δ {L}_{y} , δ {L}_{z} \}}_{t + Δ t} = {\{ {x}_{b} - {x}_{a} , {y}_{b} - {y}_{a} , {z}_{b} - {z}_{a} \}}_{t + Δ t} \qquad ( 16 )$$

$$and :$$

$${\vec{δ L}}_{t} = {\{ δ {L}_{x} , δ {L}_{y} , δ {L}_{z} \}}_{t} = {\{ {x}_{b} - {x}_{a} , {y}_{b} - {y}_{a} , {z}_{b} - {z}_{a} \}}_{t} \qquad ( 17 )$$

After performing the previous calculation, the time derivative 1516 of the vorticity vector is obtained by:

$$\frac{D \vec{ω}}{Dt} {\vert}_{c , t + Δ t} = \frac{‖ \vec{Γ} ‖}{π {σ}_{c , t}^{2} {‖ \vec{δ L} ‖}_{t}} \frac{D δ L}{Dt} {\vert}_{t + Δ t} = \frac{‖ \vec{Γ} ‖}{{V}_{c , t}} \frac{D \vec{δ L}}{Dt} {\vert}_{t + Δ t} \qquad ( 18 )$$

where ∥\vec{Γ}∥ is the magnitude of circulation, which remains constant according to Helmholtz's law. Next, the calculation of the new vorticity vector is performed in 1518; for the vortex stretching case:

$${\vec{ω}}_{c , t + Δ t} = {\vec{ω}}_{c , t} + Δ t \frac{D \vec{ω}}{Dt} {\vert}_{c , t + Δ t} \qquad ( 19 )$$

or, for the vortex squeezing case:

$${\vec{ω}}_{c , t + Δ t} = {\vec{ω}}_{c , t} - Δ t \frac{D \vec{ω}}{Dt} {\vert}_{c , t + Δ t} \qquad ( 20 )$$

In 1520, a new vortex tube volume 1612 (see FIG. 16C) was obtained based on a known vorticity ratio:

$${V}_{c , t + Δ t} = ( \frac{{‖ \vec{ω} ‖}_{c , t}}{{‖ \vec{ω} ‖}_{c t + Δ t}} ) {V}_{c , t} \qquad ( 21 )$$

Therefore, the corresponding radius of the vortex tube is:

$${σ}_{c , t + Δ t} = \sqrt{\frac{{V}_{c , t + Δ t}}{π {‖ \vec{δ L} ‖}_{t + Δ t}}} \qquad ( 22 )$$

At this point, depending on whether the flow characteristics are inviscid 1524 or viscous 1526, the calculation can be performed in two ways. For inviscid flow (see FIG. 16D), the time derivative of the vortex tube core radius is obtained by:

$$\frac{d σ}{dt} {\vert}_{c , t + Δ t}^{inviscid} = \frac{{σ}_{c , t + Δ t} - {σ}_{c , t}}{Δ t} = \frac{d σ}{dt} {\vert}_{c , t + Δ t}^{total} \qquad ( 23 )$$

On the other hand, for the viscous case 1526 (see FIG. 16E; 1614 is slightly larger than FIG. 16D), the core spreading method (CSM) can be used to obtain such a time derivative:

$$\frac{d σ}{dt} {\vert}_{c , t + Δ t}^{total} = \frac{d σ}{dt} {\vert}_{c , t + Δ t}^{inviscid} + \frac{d σ}{dt} {\vert}_{c , t + Δ t}^{viscous} = \frac{d σ}{dt} {\vert}_{c , t + Δ t}^{inviscid} + \frac{kv}{{σ}_{c , t}} \qquad ( 24 )$$

where k=1 for a Gaussian error function (erf) or k=2 for a second-order Gaussian regularization function, and ν is the fluid viscosity.

In 1528, the new total vortex tube core radius, as well as its corresponding volume 1612, were obtained by:

$${σ}_{c , t + Δ t}^{total} = {σ}_{c , t} + Δ t \frac{d σ}{dt} {\vert}_{c , t + Δ t}^{total} \qquad ( 25 )$$

$$and :$$

$${V}_{c , t + Δ t}^{total} = {πσ}_{c , t + Δ t}^{{total}^{2}} {‖ \vec{δ L} ‖}_{t + Δ t} = {V}_{s , t + Δ t}^{total} \qquad ( 26 )$$

respectively. Once the volume of vortex tube 1612 is computed, it can be represented by an equivalent vortex with the same volume 1614 at the same time step. Then, the radius of the new vortex core can be obtained 1530:

$${σ}_{s , t + Δ t}^{total} = \sqrt[3]{\frac{3 {V}_{c , t + Δ t}^{total}}{4 π}} \qquad ( 27 )$$

Next, a new total vorticity magnitude is obtained based on a known volume ratio 1532 (unitary for the inviscid case):

$${‖ \vec{ω} ‖}_{c , t + Δ t}^{total} = {‖ \vec{ω} ‖}_{c , t + Δ t} ( \frac{{V}_{c , t + Δ t}}{{V}_{c , t + Δ t}^{total}} ) \qquad ( 28 )$$

Finally, a new total vorticity vector is computed based on the known magnitude of the vorticity ratio 1534:

$${\vec{ω}}_{c , t + Δ t}^{total} = {\vec{ω}}_{c , t + Δ t} ( \frac{{‖ \vec{ω} ‖}_{c , t + Δ t}^{total}}{{‖ \vec{ω} ‖}_{c , t + Δ t}} ) \qquad ( 29 )$$

At this point, the variation in vorticity due to inviscid and viscous effects can be precisely accounted for (zero residual) by increasing or decreasing the vorton volume. This ensures the conservation of circulation and vorticity for each vortex element between two consecutive time steps and, consequently, throughout the entire simulation. To help verify the methodology, a numerical example is provided in Appendix A of the previously referenced scientific publication.

FIG. 16A shows a vortex tube 916, its inherent vortex filament 910 (with endpoints 912), and corresponding vorton 918, which has the same volume as vortex tube 916 to ensure vorticity conservation at the same instant (at t). FIG. 16B shows an advection step for a single, isolated vortex tube 916, where the subscripts 0 and 1 denote the previous (at t) 910 and current (t+Δt) 1610 positions after advection. Each vortex filament vector 910, 1610 is spatially defined by initial (a) 910 and final (b) 1610 points. FIG. 16C shows the volume of the new vortex tube (at t+Δt) 1612 after a pure inviscid advection step. This is achieved by conserving both vorticity and circulation due to the strain of the vortex filament (at t) 910 and (at t+Δt) 1610. FIG. 15D and FIG. 15E show vortex filaments 910, 1610, tubes 916, 1612, and vortons 918, 1614 for the inviscid and viscous cases, respectively.

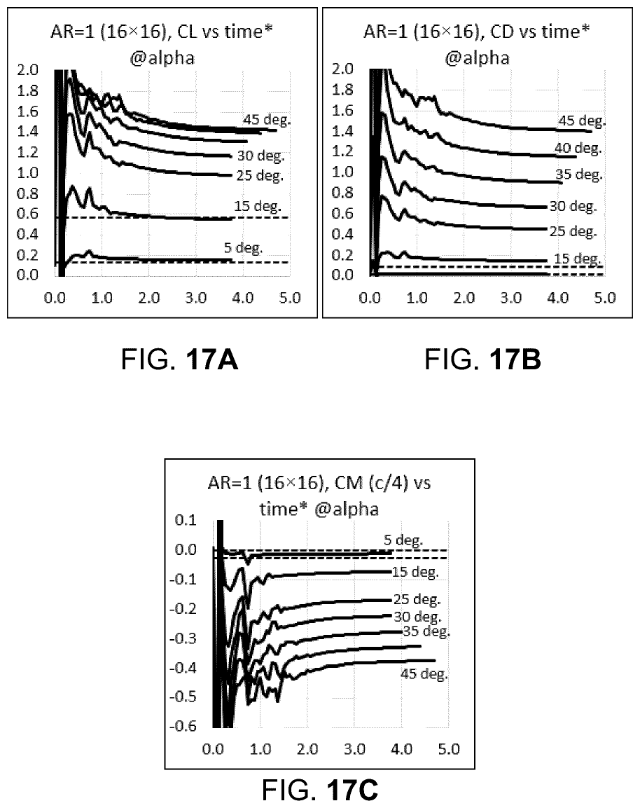

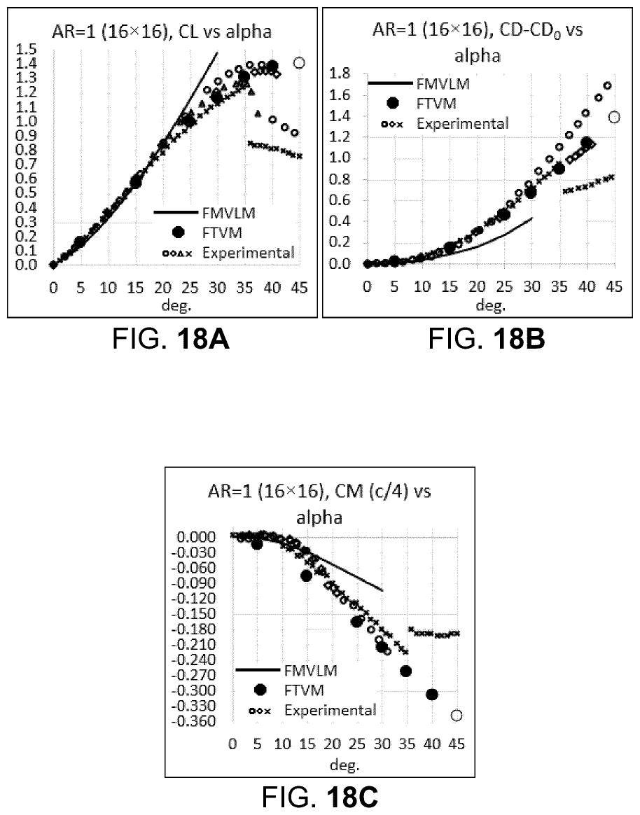

FIG. 17A, FIG. 17B, and FIG. 17C show the time-dependent numerical results achieved through the FTVM for the lift, drag, and pitching moment coefficients of a quadrangular (16×16) flat plate, respectively. As can be seen, the results are smooth, even for the highest angle of attack (AoA) cases. They reach the average steady-state values for each simulation relatively soon. FIG. 18A, FIG. 18B, and FIG. 18C show a comparison of the average steady results with experimental data for three aerodynamic coefficients (CL, CD, and CM). It must be emphasized here that this is the first time such a satisfactory result has been achieved through PFT and the vortex method concepts. This is easily attributable to the implementation of a fully detached vorticity approach (including the LEV), which forms the basis of the disclosed embodiments. Additional validation cases and experimental references can be found in the corresponding manuscript. The natural extension of the FTVM to the post-stall condition can be found in the pre-print “The Full Nonlinear Vortex Tube-Vorton Method: the post-stall condition” (arXiv.org, 2025).

Although the disclosed embodiments are described in detail in connection with the currently known best mode of invention, they are not limited to the specified embodiments described herein. Rather, the disclosed embodiments can be modified to incorporate any number of variations, alterations, substitutions, or equivalent arrangements not heretofore described.

Modifications to the described embodiments are possible, as are other embodiments within the scope of the claims.

What is claimed is:

1. A method for simulating fluid dynamics related to objects on a display device, comprising:
a) calculating a nonlinear shedding circulation-vorticity scheme, both in steady and transient states, for an influence coefficient matrix (ICM) and a right-hand side (RHS) contribution to assemble a system of equations;
b) calculating a plurality of shedding circulation elements with intensities and orientations from surface element edges of the objects based on the nonlinear shedding circulation-vorticity scheme;
c) generating a single-vorton or multiple-vorton scheme per vortex filament for discretizing bounded vorticity to the body; and
d) generating a plurality of nascent vortex elements with intensities and orientations on surfaces of the objects.

2. The method and system for simulating on a display device as set forth in claim 1, further comprising:
a) calculating vorticity advection by determining vortex squeezing and stretching of a plurality of hybrid elements comprising vortex tubes and vortons, thereby allowing for volume variation with each iteration; and
b) calculating viscous diffusion of the plurality of hybrid elements comprising vortex tubes and vortons by determining the variation of their vorticities due to fluid viscosity.

3. The method and system for simulating on a display device according to claim 1, further comprising calculating a resultant force and moments on the body from a total induced velocity field, including a contribution of any leading edge vortex.
